(19) United States
(12) Patent Application Publication
(10) Pub. No.: US 2023/0228574 A1
(43) Pub. Date: Jul. 20, 2023

(54) Dual-rotation modulation technique - based inertial sensor

(71) Applicant: VIETTEL GROUP, Ha Noi City (VN)

(72) Inventors: XUAN CHIEN VUONG, Ha Noi City (VN); DUC ANH NGUYEN, Ha Noi City (VN); VAN HIEP HOANG, Ha Noi City (VN); HAI NAM TRINH, Tho Xuan District (VN)

(73) Assignee: VIETTEL GROUP, Ha Noi City (VN)

(21) Appl. No.: 18/151,077

(22) Filed: Jan. 6, 2023

(30) Foreign Application Priority Data
Jan. 19, 2022 (VN) 1-2022-00376

(51) Int. Cl. G01C 21/16; G01C 25/00

(52) U.S. Cl. CPC G01C 21/188; G01C 25/00; G01C 21/165; G01C 21/166

(57) ABSTRACT

The invention provides an inertial sensing device the capability to achieve self-alignment (sensor error compensation), by using dual-rotation modulation technique. The self-alignment process is performed based on fully building the sensor's mathematical model and rotating the inertial sensor blocks in a specific order. The advantages of this technology are fast calibration time, high accuracy, and the ability to separate independent movements on the axes of the inertial sensor. The inertial sensor based on a dual-rotation modulation platform is applied to marine and aeronautical fields.

### TECHNICAL FIELD OF INVENTION

The calibration process of inertial systems is extremely important. The misalignment angle and sensor error cause large deviations in the convergence, which reduce the accuracy of the inertial navigation algorithm's results. Therefore, the improvement of the correction calibration will significantly increase the performance of the inertial navigation system.

In recent years, sensor error compensation technology has been widely used in the field of inertial navigation. In particular, some popular and innovative technologies are capable of overcoming and correcting the initial errors of the inertial navigation system, as follows:

Chinese patent CN106500694, published on Mar. 15, 2017, by LI JIE et al., provides a miniature rotary micro-inertia measuring device. This structure can't compensate for the error on all axes of the inertial sensor, especially since the error is always changing over time, which makes this navigation system's accuracy gradually decrease.

Chinese patent CN109029500, published on Dec. 18, 2018, by JI CUIPING et al., provides a self-calibration method based on dual-axis rotary modulation system. A three-axis inertial sensor will be rotated on a two degrees of freedom platform, thereby estimating all axes's error. However, the inertial navigation process and continuous calibration can't be implemented simultaneously, so the positioning accuracy still decreases over time.

### SUMMARY OF THE INVENTION

To overcome the disadvantages of the previous inventions, the authors propose an inertial sensor's mechanism with two independent axes of rotation, which allows the system to be able to perform two processes at the same time: continuous calibration and running the inertial navigation algorithm, thereby increasing the accuracy of the navigation system and reducing the cost compared to sensors with equivalent navigation quality.

Dual-rotation modulation technique-based inertial sensor has the following main components:
The housing;
Multi-sensor synchronized section;
Central processing section;
Positioning signal receiver section.

### BRIEF DESCRIPTION OF THE DRAWINGS

FIG. 1: Overview of inertial sensor based on dual-rotation modulation technique.

FIG. 2: The main components of inertial sensor based on dual-rotation modulation technique.

FIG. 3: Multi-sensor synchronized section.

FIG. 4: Central processing section.

FIG. 5: Block diagram of the communication circuit.

FIG. 6: The main components of the communication circuit.

FIG. 7: Block diagram of the sensor reading circuit.

FIG. 8: The main components of the sensor reading circuit.

FIG. 9: Block diagram of the converter circuit.

FIG. 10: The main components of the converter circuit.

### DETAILED DESCRIPTION OF INERTIAL SENSOR

In this invention, the dual-rotation modulation technique-based inertial sensor combines many critical components, each of which has specific functions and tasks but is closely linked and complements each other to form a unified sensor block.

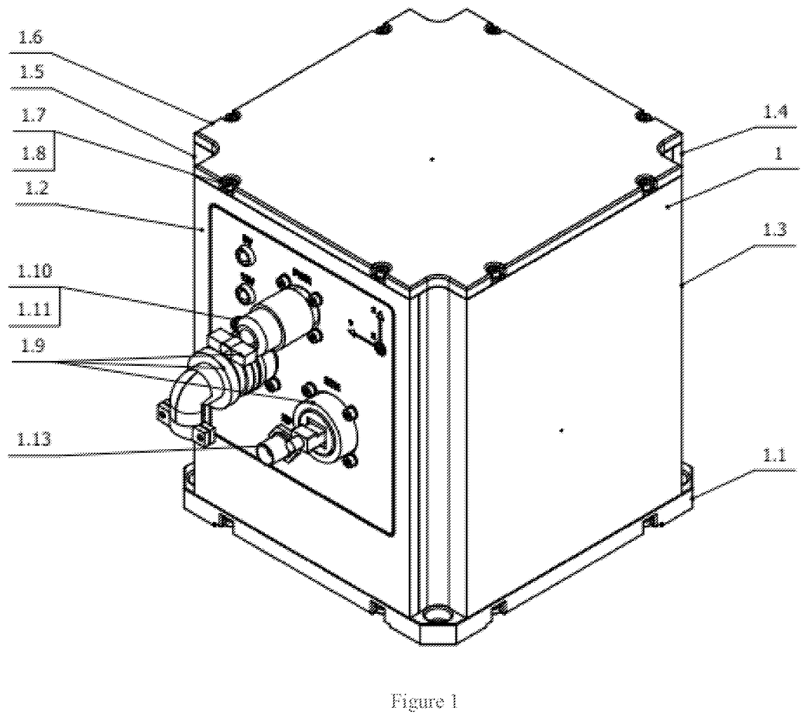

FIG. 1 illustrates an inertial sensor based on a dual-rotation platform. The outermost layer that covers and protects the internal components is the housing 1, which include six plates: base plate 1.1, connector plate 1.2, circuit plate 1.3, sensor plate 1.4, motor plate 1.5, and cover plate 1.6, all of which are suitably machined and anodized aluminum processes with a thickness of 20 μm. The housing's plates are tightly mounted together by hex socket head cap screws 1.7 size M3x L10 and spring lock washers 1.8, opening up a safe space inside to house important electronic components. Connectors 1.9 are firmly mounted on the face of the connector plate 1.2 by hex socket head cap screws 1.10 size M3xL12 and spring lock washers 1.11 so that the power and signal lines of the device are guaranteed to operate smoothly. GPS (Global Positioning System) signal is received from a positioning antenna 1.13, providing the initial position value for the sensor. In addition, for users to easily grasp information about the device's source, indicator lights 1.12 are neatly arranged on the face of the connector plate 1.2.

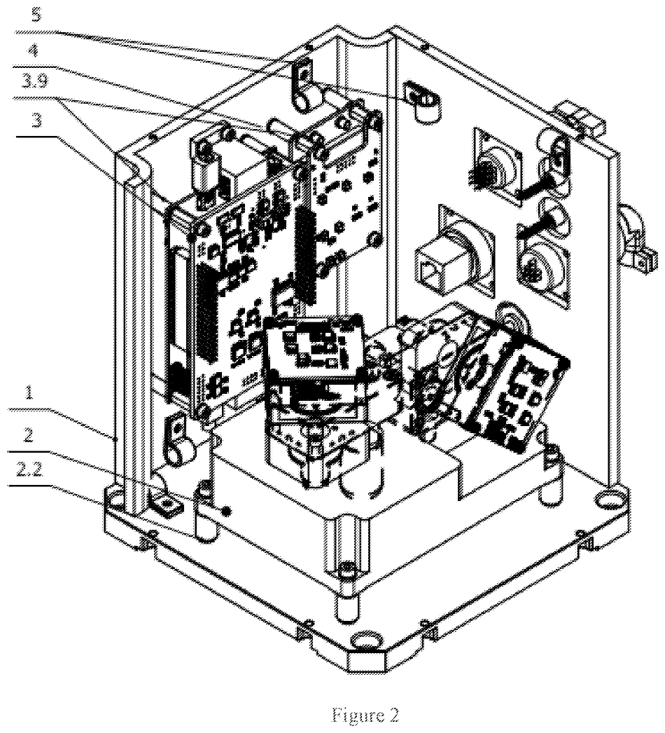

FIG. 2 shows the main components of the inertial sensor based on the dual-rotation platform inside housing 1. The multi-sensor synchronized section 2 is located on base 1.1 through a large anti-vibration system 2.2. The central processing section 3 and the positioning signal receiver section 4 are both fastened on circuit plate 1.3 through a small anti-vibration system 3.9. In addition, by using wire clips 5, the lines connecting the main components inside housing 1 are fixed during operation.

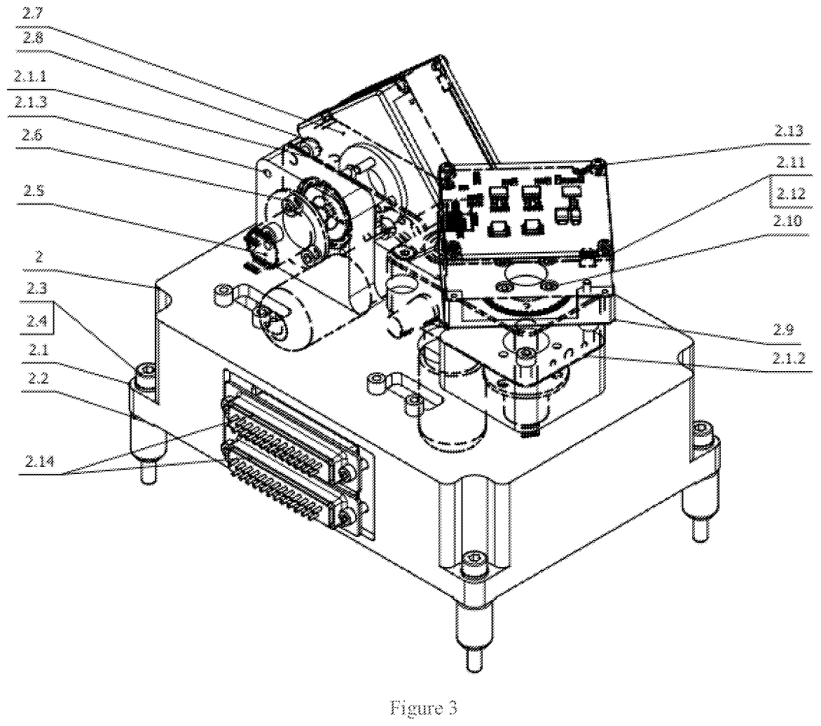

As the detailed drawing is shown in FIG. 3, the multi-sensor synchronized section 2 is composed of modules, which are firmly linked together to form a unified block. Base 2.1 is an important component, which plays a role in shaping the sensor posture, containing the slip ring to enhance the rotation of the engine and support anti-vibration. The base consists of two sides that are intricately machined from aluminum alloy, vertical plane 2.1.1 and horizontal plane 2.1.2, these two planes are designed the same, operate independently of each other, and are used to install link assemblies to connect with other components. In addition, the base is linked to housing 1 by a large anti-vibration system 2.2, spring lock washers 2.4, and hex socket head cap screws 2.3 sizes M4xL12. A slip ring 2.5 is fastened to the vertical plane 2.1.1 by hex socket head cap screws 2.6 sizes M3xL10. Meanwhile, motor 2.7 uses hex socket head cap screws 2.8 size M3xL12, and screw holes 2.1.3 to attach to the vertical plane 2.1.1. A support plate 2.9 connects to the rotor part of the motor 2.7 via hex socket head cap screws 2.10 size M2.3xL8. Support plate 2.9 facilitates a sensor 2.11 and its reading circuit 2.12 to be fastened by hex socket head cap screws 2.13 size M2xL20. In addition, communication ports 2.14 (DB25 type) are designed on base 2.1 to transmit, receive signals, and power the modules on the multi-sensor synchronized section 2.

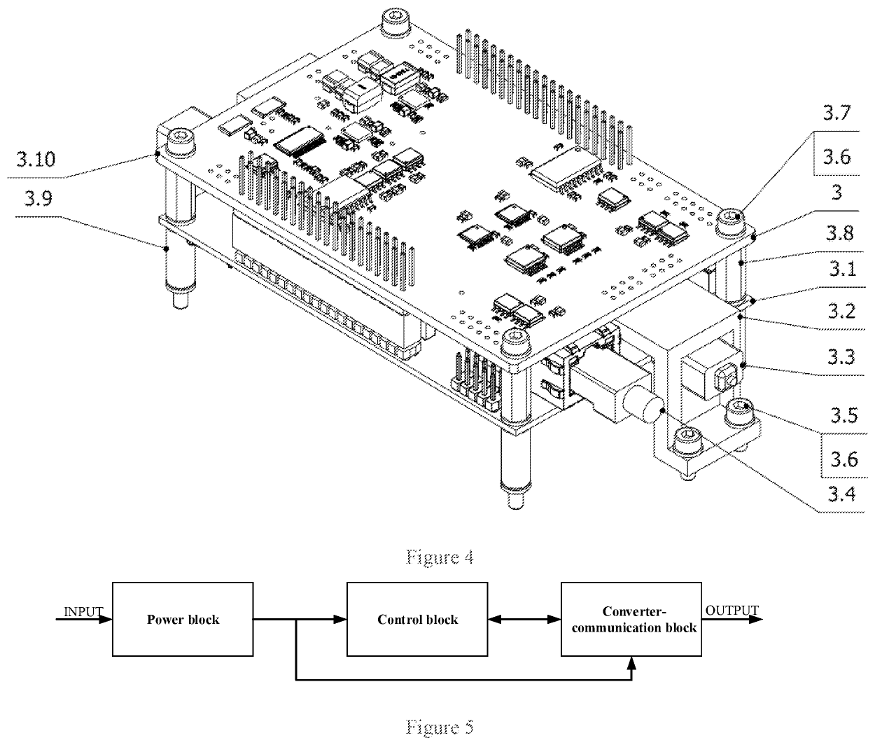

The central processing section 3, as depicted in FIG. 4, is made up of two main components, a processing circuit 3.1 (FPGA) and a communication circuit 3.10, these two components are linked together by hex socket head cap screws 3.6 size M3xL6, spring lock washers 3.7 and brass spacers 3.8 size M3xL14. A heatsink 3.2 is installed close to the processing circuit by spring lock washers 3.5 and hex socket head cap screws 3.6 size M3xL10 so that the heat generated during operation of processing circuit 3.1 is transferred to housing 1. In addition, the processing circuit 3.1 has connection ports including a network port 3.4 and a configuration port 3.3, these ports help users to communicate and control the circuit from the outside. Finally, the central processing section 3 is mounted to circuit plate 1.3 of housing 1 by a small anti-vibration system 3.9 sizes M3xL15.

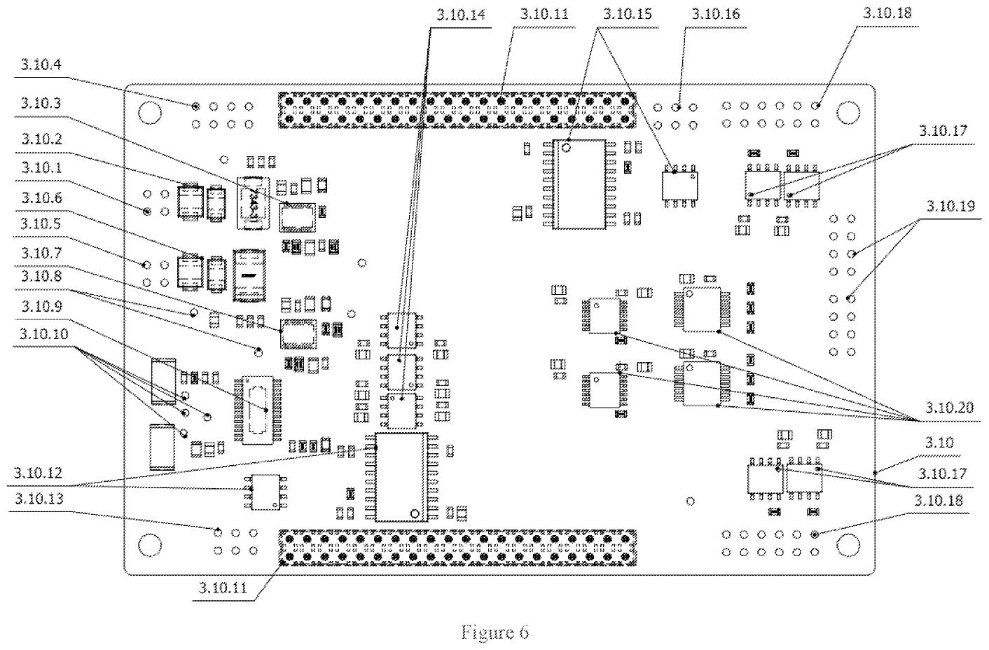

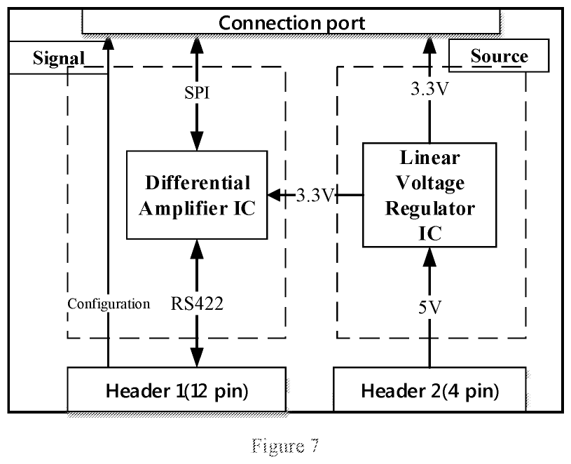

FIGS. 5 and 6 are detailed descriptions of the principle and structure of communication circuit 3.10, which is made up of three blocks: a power block, a control block, and a converter-communication block. The inputs to the power block are 5V power and 12V power, which are provided by external devices through ports 3.10.1 and 3.10.5. These power lines pass through anti-reverse diodes 3.10.2 and 3.10.6, before being fed to outputs 3.10.4 and 3.10.8 to provide power to other critical components such as processing circuit 3.1, the sensor reading circuits 2.12, and converter circuit 4.1. Linear voltage regulator ICs 3.10.3 and 3.10.7 are responsible for reducing from the voltage of 5V and 12V power to 3.3V power, which supply to all signal conversion and isolation chips on communication circuit 3.10. The control block is powered by a 12V power obtained from the power block. A bipolar Motor Driver Power IC 3.10.9 has the role of controlling the output power through ports 3.10.10 to supply power to the motor 2.7. The converter-communication block includes connections for processing circuit 3.1, the positioning signal receiver section 4, the sensor reading circuit 2.12, the encoder built-in the motor 2.7, and the device's output signals. In this converter-communication block, processing circuit 3.1 connects the signal to communication circuit 3.10 via pins 3.10.11; the positioning signal receiver section 4 can connect to communication circuit 3.10 through port 3.10.13 thanks to a positioning converter chip 3.10.12. Isolation chips 3.10.14 have the function of protecting the signal lines from the control block to the conversion-communication block. Besides, the device's output signal is put through a protocol port 3.10.16 thanks to a differential amplifier converter IC 3.10.15. The encoder's signal (of motor 2.7) is fed to communication circuit 3.10 through differential ports 3.10.19, converting the signal from high to low and performing isolation thanks to a voltage level translator IC 3.10.20. The signals of sensor reading circuit 2.12 are connected to communication circuit 3.10 via ports 3.10.18 and are converted by the isolation and conversion chips 3.10.17.

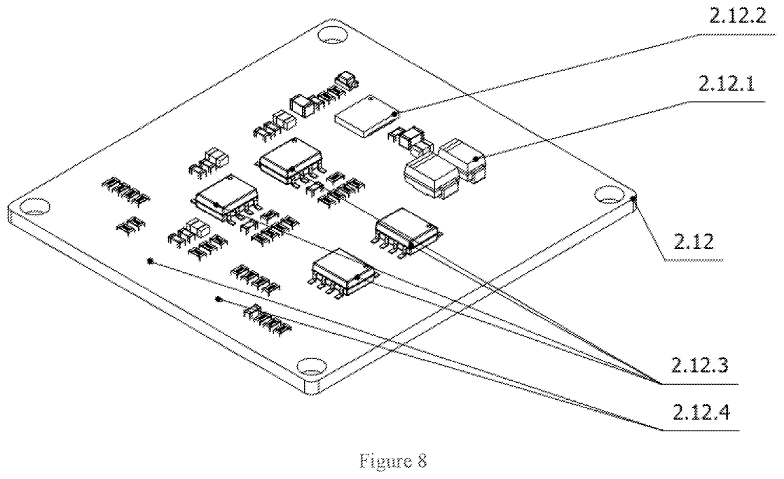

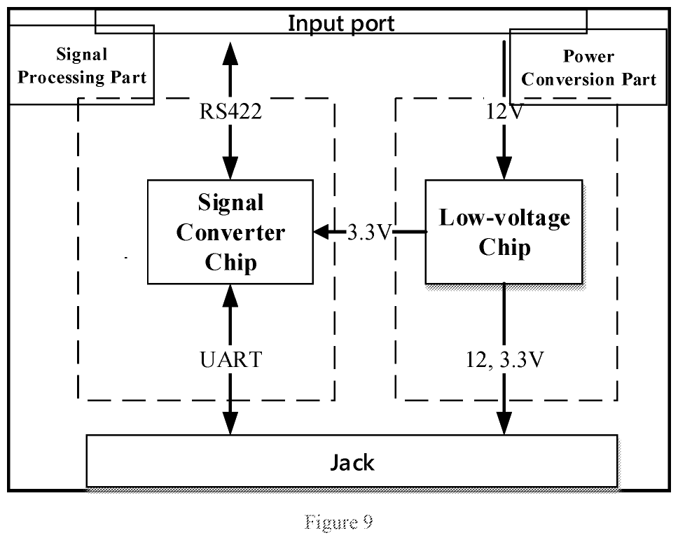

FIGS. 7 and 8 are diagrams detailing the components and structure of sensor reading circuit 2.12. As shown in FIG. 7, the sensor reading circuit consists of two main parts: a signal part (SPI protocol and configuration) and a source part. Circuit 2.12 is powered by 5V input. After going through a semiconductor diode 2.12.1 to prevent reverse current, this 5V power line is passed through a linear voltage regulator IC 2.12.2 to lower the voltage from 5V to 3.3V to supply the converter chips and sensor 2.11. Differential amplifier chips 2.12.3 are responsible for converting the SPI signal (a synchronous protocol standard) to a differential form so that the signal can be transmitted further. Port 2.12.4 is added to connect the signal and provide power to sensor 2.11.

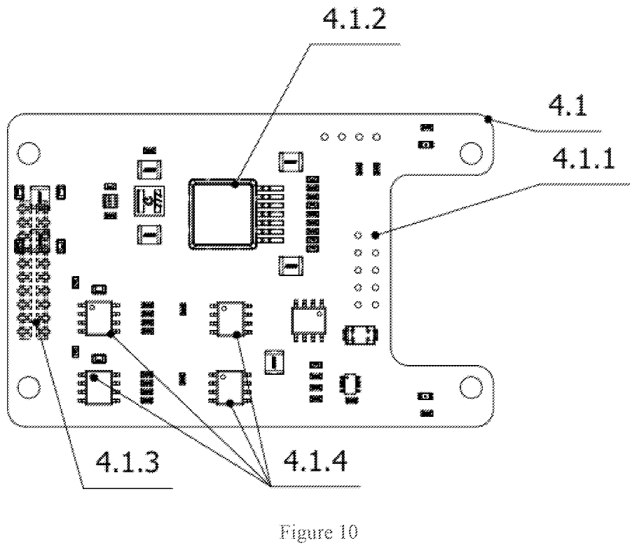

Similarly, FIG. 9 and FIG. 10 are diagrams detailing the components and structure of converter circuit 4.1. As shown in FIG. 9, this circuit consists of two main parts: a signal processing part, and a power conversion part. The power conversion part is supplied with a 12V line from the outside (communication circuit 3.10) through port 4.1.1, this power line continues to pass through a low-voltage chip 4.1.2 to become a 3.3V to power signal converter chips 4.1.4. In addition, the 3.3V and 12V power lines are also supplied to the signal receiver circuit through jack 4.1.3. The signal processing part is taken as input from port 4.1.3 according to the UART standard (serial communication standard), and an output signal is put through signal converter chips 4.1.4 into differential lines and transferred to port 4.1.1.

### CONCLUSION

An inertial sensor is based on a dual-rotation platform consisting of the main components: a housing, a multi-sensor synchronized section, a central processing section, and a positioning signal receiver section. The present invention provides a method of designing the installation of sensors with two independent axes of rotation, facilitating the implementation of sensor self-calibration technologies. Therefore, despite using inexpensive, easily accessible components on the market, inertial sensor based on dual-rotation modulation technique has achieved accuracy comparable to high-precision class expensive sensors.

What is claimed is:

1. An inertial sensor based on a dual-rotation platform, comprising the following: a housing, and three components, a multi-sensor synchronized section, a central processing section, and a positioning signal receiver section, in which:
the housing includes six plates: a base plate, a connector plate, a circuit plate, a sensor plate, a motor plate, and a cover plate, outside the housing, a number of connection ports, a number of indicator lights, and a number of positioning antennas are arranged on the connector plate, at an inside of the housing, the three components are mounted in the following positions: the multi-sensor synchronization section is placed on the base plate through a large anti-vibration system; the central processing section and the positioning signal receiver section are securely mounted on the circuit plate via a number of anti-vibration systems, a number of wire clips are provided for connecting;
the multi-sensor synchronized section consists of plural modules, including a base having two perpendicular planes used to shape a posture of the inertial sensor: a first sensor is placed horizontally in a first plane, and a second sensor is placed vertically in a second plane, mounted on each plane of the base are: a motor and a slip ring, a sensor and a sensor reading circuit are driven through a support plate placed on a rotor of the motor, in addition, the base is powered and converted through a DB25-type communication port,
the sensor reading circuit is a part of the multi-sensor synchronized section, and comprises two parts: a signal part and a source part, the source part has a role of reducing a power voltage from 5V to 3.3V, supplying chips of the sensor reading circuit and the signal part, which convert ones of a synchronous protocol standard signals to a differential form for further transmission;
the central processing section comprises two main components: a processing circuit and a communication circuit, wherein the processing circuit has a function of calculating and controlling activities of the device, and the communication circuit has a function of supplying power and exchanging signals between the processing circuit and other portions in the sensor, the processing circuit and the communication circuit are mounted together by a number of brass spacers, spring lock washers, and hex socket head cap screws, a heatsink is provided to the processing circuit to transfer heat generated during the circuit's operation to outside of the housing,
the communication circuit comprises of three main blocks: a power block, a control block, and a converter-communication block, the power block provides an anti-reverse and a low-voltage to supply the modules and the control block, and the converter-communication block, the control block adjusting an output source to perform a motor control function, the converter-communication block communicating, collecting, and processing conversions from blocks and other parts of the inertial sensor;
the positioning signal receiver section comprises two main components: a signal receiver circuit and a converter circuit, the signal receiver circuit is a GPS circuit, for collecting and processing signals to give positioning results, the converter circuit processing, signal conversion, and reducing voltage to provide to the signal receiver,
the converter circuit has two main components: a signal processing part and a power conversion part, the power conversion part protecting and reducing voltage to a level, the signal processing part converts the signal of the receiver circuit into differential signals.
